(19) United States
(12) Patent Application Publication
(10) Pub. No.: US 2014/0255813 A1
(43) Pub. Date: Sep. 11, 2014

(54) ENERGY GENERATION AND STORAGE USING ELECTRO-SEPARATION METHODS AND DEVICES

(71) Applicant: BlueCell Energy, LLC, Research Triangle Park, NC (US)

(72) Inventor: Ryan Scott Kingsbury, Durham, NC (US)

(21) Appl. No.: 14/201,687

(22) Filed: Mar. 7, 2014

Related U.S. Application Data
(60) Provisional application No. 61/776,691, filed on Mar. 11, 2013.

(51) Int. Cl. H01M 8/18

(52) U.S. Cl. CPC H01M 8/184
USPC 429/451; 429/499

(57) ABSTRACT

Systems and methods for the storage of energy that can be easily converted to electrical power are disclosed. A concentration battery includes a stack of alternating cation and anion exchange membranes separated from one another by alternating first and second spaces; a first reservoir containing a concentrated ionic solution; a second reservoir containing a dilute ionic solution; multiple spaced first fluid pathways in fluid communication with the first reservoir and configured to flow concentrated ionic solution flows into the first spaces; and multiple spaced second fluid pathways in fluid communication with the second reservoir and configured to flow dilute ionic solution flows into the second spaces. The fluid pathways may be configured to flow the ionic solutions in a common first direction. Electrodes at either end of the device in fluid communication with the concentrated ionic solution permit electrical energy to be applied or extracted. A related method is included.

### CROSS-REFERENCE TO RELATED APPLICATIONS

This application claims priority to U.S. Provisional Patent Application No. 61/776,691 filed on Mar. 11, 2013, the entire contents of which are hereby incorporated by reference.

### TECHNICAL FIELD

One or more aspects of this technology relate generally to the field of electro-separation processes. More particularly, one or more aspects involve the use of electrodialysis and reverse electrodialysis for the reversible production and storage of energy.

### BACKGROUND

The need for ever-growing supplies of electrical energy and the threat of global climate change demand more efficient electrical distribution infrastructures. A need for cost-effective large-scale energy storage technology in not currently met. To date, leading battery technologies store energy as oxidation-reduction potential between two chemicals, leading to high cost and limiting the scale at which they can be deployed.

One method of storing electrical energy involves the use of an electrodialysis apparatus commonly used for the production of table salt, treatment of certain industrial wastes, and food processing. However, various disadvantages are associated with traditional electrodialysis and reverse electrodialysis. The devices and methods described herein constitute a technique for storing and generating electricity using a modified electrodialysis apparatus. A conventional electrodialysis apparatus consists of a stack of alternating membranes, in which the first type of membrane is permeable only to positively-charged ions (cations), and the second type of membrane is permeable only to negatively-charged ions (anions). A first solution is passed through a first space defined by opposing faces of the anion and the cation exchange membrane, while a second fluid is passed through a second space defined by the other face of the cation exchange membrane and the opposite face of the next anion exchange membrane in the stack. When an electrical current is passed through this stack (usually by electrodes located at the far ends of the stack), electrostatic forces cause both positive and negative ions to migrate from the first solution into the second solution, such that the first solution becomes more dilute and the second solution becomes more concentrated.

The object of the one or more devices, systems, and methods disclosed herein is to demonstrate that traditional electrodialysis and reverse electrodialysis may be combined into a reversible, closed-loop process for the storage and generation of electricity, and that doing so mitigates several operating constraints associated with these individual processes.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

In at least one embodiment a method for generation and storage of energy includes: providing a first electrolyte solution; providing a second electrolyte solution; in a modified electrodialysis apparatus, circulating flows of the first solution and the second solution through separate chambers while electrical voltage is applied across the electrodes of the apparatus, thereby causing ions to move through the membrane from the first solution to the second solution thereby storing chemical potential energy in the form of a concentration gradient between the two. In a second part of the method, the first (dilute) and second (concentrated) solutions are circulated through separate chambers of the apparatus thereby creating a membrane potential, and said membrane potential gives rise to electric current that is captured at the electrodes. The method may include converting a membrane potential defined by the concentration difference between the dilute solution and the concentrated solution across a membrane into an electrical current.

According to one or more embodiments, a method for storing and releasing electrical energy is provided. The method includes placing a first electrolyte solution in a first flow channel defined between an anion exchange membrane (AEM) and a cation exchange membrane (CEM) and a second electrolyte solution in a second flow channel defined between an AEM and a CEM. The method includes passing electrical current through the flow channels to cause the first solution to become more dilute and the second solution to become more concentrated. The method includes circulating the dilute solution into a dilute solution flow channel defined between an AEM and a CEM and the concentrated solution into a concentrated solution flow channel defined between an AEM and a CEM. The concentration difference between the dilute solution and the concentrated solution generates membrane potentials that are converted to electrical current.

According to one or more embodiments, the method includes adding chemical salts to a water solution to form the first electrolyte solution and the second electrolyte solution.

According to one or more embodiments, the salt concentration in each of the first electrolyte solution and the second electrolyte solution are about the same.

According to one or more embodiments, the salt concentration in each of the first electrolyte solution and the second electrolyte solution are equal.

According to one or more embodiments, the first electrolyte solution and/or the second electrolyte solution contain one or more unique chemical components (ionic species) that are not present in the other solution.

According to one or more embodiments, adding chemical salts to a water solution includes adding a salt at greater than 0.5 molar concentration.

According to one or more embodiments, one or more of the AEMs or CEMs are selective toward monovalent ions.

According to one or more embodiments, the ions that are added to each of the first and second electrolyte solutions include at least one monovalent cation, at least one monovalent anion, and at least one multivalent cation or anion.

According to one or more embodiments, the predominant anion (by concentration) in the first or second electrolyte solution is from one of formate, acetate, chloride, bromide, and iodide.

According to one or more embodiments, the predominant cation (by concentration) in the first or second electrolyte solution is from one of sodium, potassium, cesium, and ammonium.

According to one or more embodiments, either the first or the second solution is configured to flow through both the anode and cathode flow spaces.

According to one or more embodiments, the method includes placing the first solution to flow through the anode flow space and placing the second solution to flow through the cathode flow space.

According to one or more embodiments, any solution configured to flow through the anode or cathode flow spaces contains a soluble redox couple.

According to one or more embodiments, the soluble redox couple is Iron(II)/Iron(III).

According to one or more embodiments, the first flow channel is the dilute flow channel, and the second flow channel is the concentrated channel.

According to one or more embodiments, the method includes storing the electrical current in a battery.

According to one or more embodiments, the method includes converting the electrical current for connection to an electrical load.

According to one or more embodiments, the spacing between an adjacent AEM and CEM is between about 0.5 mm and about 2.5 mm.

According to one or more embodiments, a reversible electrodialysis system is provided. The system includes an electrodialysis apparatus that includes a stack of one or more membrane flow cells, each cell comprising an anion exchange membrane (AEM) and a cation exchange membrane (CEM), a first solution inlet through which a first electrolyte solution is introduced to a first flow channel defined by a first surface of an AEM and first surface of an adjacent CEM, a second solution inlet through which a second electrolyte solution is introduced to a second flow channel defined by the opposite surface of an AEM or CEM and a first surface of an adjacent AEM or CEM, a cathode compartment and an anode compartment, and a control module. The control module is configured to direct a first solution through the first solution inlet into the first flow channel and direct a second solution through the second solution inlet into the second flow channel, direct an electrical source to apply electrical potential to the apparatus to cause migration of ions from respective first and second solutions to form a dilute solution and a concentrated solution, direct a pump to pump the dilute solution into a dilute solution storage tank and pump the concentrated solution into a concentrated solution storage tank, determine a peak energy demand period for an electric grid, and in response to determining a peak energy demand period, direct a pump to pump dilute solution into a dilute solution flow channel and pump concentrated solution into a concentrated solution flow channel in an electrodialysis apparatus to generate energy for delivery to an electrical load.

According to one or more embodiments, the cathode and anode compartment contain capacitative electrodes.

According to one or more embodiments, the spacing between an adjacent AEM and CEM is between about 0.5 mm and about 2.5 mm.

According to one or more embodiments, a method for storing and releasing electrical energy is provided. The method includes placing a first electrolyte solution in a first flow channel defined between an anion exchange membrane (AEM) and a cation exchange membrane (CEM) and a second electrolyte solution in a second flow channel defined between an AEM and a CEM, applying electrical current through the flow channels to cause the first solution to become more dilute and the second solution to become more concentrated by ion exchange, circulating the dilute solution into a dilute solution flow channel defined between an AEM and a CEM and the concentrated solution into a concentrated solution flow channel defined between an AEM and a CEM, and converting the concentration difference between the dilute solution and the concentrated solution into an electrical current.

According to one or more embodiments, a method for storing and releasing electrical energy is provided. The method includes placing a first electrolyte solution in a first flow channel defined between an anion exchange membrane (AEM) and a cation exchange membrane (CEM) and a second electrolyte solution in a second flow channel defined between an AEM and a CEM, during a period of low energy demand, applying electrical current through the flow channels to cause the first solution to become more dilute and the second solution to become more concentrated by ion exchange, during a period of high energy demand, circulating the dilute solution into a dilute solution flow channel defined between an AEM and a CEM and the concentrated solution into a concentrated solution flow channel defined between an AEM and a CEM, and converting the concentration difference between the dilute solution and the concentrated solution into an electrical current.

### BRIEF DESCRIPTION OF THE DRAWINGS

FIG. 1 is a flowchart that illustrates one or more embodiments of the method disclosed herein.

FIG. 2 is an exemplary process schematic illustrating an arrangement of storage tanks, pumps, and electro-separation unit for a reversible storage and generation of electrical energy according to one or more embodiments disclosed herein.

FIG. 3 is an exemplary schematic of an electro-separation apparatus configured for the reversible storage and generation of electrical energy according to one or more embodiments disclosed herein.

FIG. 4 is a schematic of an apparatus used to determine the resistance of ion exchange membranes in concentrated electrolyte solutions according to one or more embodiments disclosed herein.

FIG. 5 is a graph illustrating the total resistance of ionic solutions and ionic exchange membranes in sodium chloride solution according to one or more embodiments disclosed herein.

FIG. 6 is a graph illustrating the electrical resistivity of ionic exchange membranes in sodium chloride solution according to one or more embodiments disclosed herein.

FIG. 7 is a graph illustrating the total resistance of ionic solutions and ionic exchange membranes in sodium formate solution according to one or more embodiments disclosed herein.

FIG. 8 is a graph illustrating the electrical resistivity of ionic exchange membranes in sodium formate solution according to one or more embodiments disclosed herein.

FIG. 9 is a graph showing the electrical membrane potential stored in a concentration gradient over a one month period according to one or more embodiments disclosed herein.

FIG. 10 is a chart showing current-voltage curves comparing the electrical resistance of an electrodialysis apparatus resulting from seawater and from a highly concentrated chemical salt solution according to one or more embodiments disclosed herein.

### DETAILED DESCRIPTIONS

While the disclosure of the technology herein is presented with sufficient details to enable one skilled in this art to practice the one or more inventions disclosed herein, it is not intended to limit the scope of the disclosed technology. The inventors contemplate that future technologies may facilitate additional embodiments of the presently disclosed subject matter as claimed herein. Moreover, although the term “step” may be used herein to connote different aspects of methods employed, the term should not be interpreted as implying any particular order among or between various steps herein disclosed unless and except when the order of individual steps is explicitly described.

The devices and methods described herein constitute a technique for storing and generating electricity using one or more modified electrodialysis apparatus. An electrodialysis apparatus is commonly used in the production of table salt, the treatment of certain industrial wastes, and in food processing. A conventional electrodialysis system includes a stack of alternating membranes, in which the first type of membrane is permeable only to positively-charged ions (cations), and the second type of membrane is permeable only to negatively-charged ions (anions). A first solution is passed through a first space defined by opposing faces of the anion and the cation exchange membrane, while a second fluid is passed through a second space defined by the other face of the cation exchange membrane and the opposite face of the next anion exchange membrane in the stack. When an electrical current is passed through this stack (usually through electrodes located at the far ends of the stack), electrostatic forces cause both positive and negative ions to migrate from the first solution into the second solution, such that the first solution becomes more dilute and the second solution becomes more concentrated. In the course of this electrodialysis process, impurities in the feed solutions may clog the respective membranes. As such it is common to practice “electrodialysis reversal” in which the polarity of the electrical current through the stack is momentarily reversed to remove the fouling. This practice reverses the flow of ions (thus negating the treatment or production objective), but helps remove the impurities and prolong the life of the membranes.

A second variation on traditional electrodialysis is termed “reverse electrodialysis.” In this mode, no electrical power is supplied to the membrane stack. Rather, two solutions of differing ion concentration (often river water and sea water) are used as the first and second solutions. As they pass through the membrane stack, the natural tendency of ions to diffuse down the concentration gradient causes electrical power to be generated. Due to challenges associated with high electrical resistance of the solutions, this technology is not yet practical for commercial adoption, but is an active area of research as it promises an abundant source of clean energy.

Various aspects of conventional and reverse electrodialysis systems have been described in the art. In all cases, reverse electrodialysis systems are configured as one-way processes, designed to exploit the mixing of naturally-occurring continuous flow streams, such as sea water and river water, or desalination brine and seawater. This bias towards one-way, continuous-flow operation is necessary for continuous power generation, but limits the range of solution compositions to naturally or industrially occurring streams. Such a restriction imposes several limitations on the performance of the apparatus. First, both the dilute solution (river or sea water) and the ion exchange membranes in contact with it have a high electrical resistance, causing energy losses during power generation. To minimize the solution resistance, it is necessary to make the spaces between membranes very small, on the order of between 0.05 mm and 0.5 mm, thus increasing the energy losses from pumping. Finally, since reverse electrodialysis systems operate in only one direction and use naturally occurring solutions, they are subject to fouling due to organic matter, precipitates, and suspended particles.

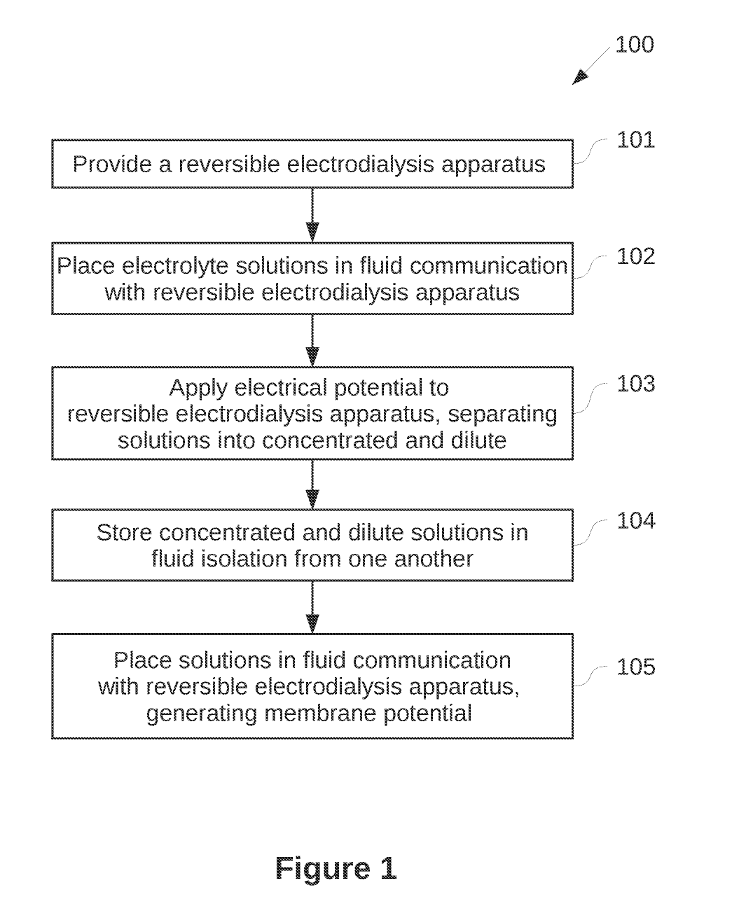

The one or more inventions disclosed herein include a method (100) by which electrodialysis and reverse electrodialysis may be combined into a reversible, closed-loop process for the storage and generation of electricity, according to the one or more processes illustrated in FIG. 1. In one or more embodiments, a reversible electrodialysis apparatus is provided (101). The apparatus may be any of the devices disclosed and further described herein.

The method may further include storing and circulating two aqueous solutions containing chemical salts through the reversible electrodialysis apparatus in a substantially closed loop (102). As used herein, salts refer to any substances that produce dissolved ions in aqueous solution, and substantially closed loop may mean that the flow channels used for steps (103) and (105) are one in the same and no external addition of solution may be provided when between steps (103) and (105) as further described herein.

To store energy, electrical potential is applied to the apparatus (103) by applying voltage across the electrodes, which are further described below, causing the apparatus to operate in forward or conventional electrodialysis mode. Ions from one of the solutions migrate across the respective ion exchange membranes into the other solution, creating a more concentrated and a more dilute solution. This separation creates a concentration gradient between the two solutions. In one or more embodiments, no side streams or waste products are generated during this step. In one or more embodiments, the first flow solution is provided into a first flow channel that is defined between an anion exchange membrane (AEM) and a cation exchange membrane (CEM) and the second flow solution is provided into a second flow channel that is defined between an AEM and a CEM. The first and second flow channels may share a common AEM or CEM. The first flow solution and the second flow solution may include solutions with generally equal salt concentrations, or may have varying salt concentrations. The first flow solution and the second flow solution may each have a salt concentration of greater than 0.5 molarity. In this manner, due to the travel of ions across the AEM and CEM, a dilute solution and a concentrated solution are formed after passage of the solutions in the electrodialysis apparatus.

In one or more embodiments, power is disconnected and the two solutions are stored (104). The dilute solution is stored in a dilute solution storage tank and the concentrated solution is stored in a concentrated solution storage tank. This storage may occur over a defined short period of time, such as a few minutes or hours, or may occur for a prolonged period of time, such as over several days, or an indefinite time period, such as when the apparatus is used to provide standby or backup power. In one or more embodiments, this storage may be between the period of low electricity demand and high electricity demand at a utility plant or renewable energy installation.

In one or more embodiments, the concentrated and dilute solutions are circulated through the reversible electrodialysis unit (105) to release energy and cause it to operate in reverse electrodialysis mode. In these one or more embodiments, the concentration gradient causes ions in the concentrated solution to migrate into the dilute solution, and the arrangement of ion exchange membranes forces ionic current to flow in only one direction, allowing electricity to be captured in an external DC circuit.

Conversion of this DC current to useful grid power can be accomplished using commercially available equipment. In this way, the apparatus can be used in conjunction with any type of electrical power generating equipment to provide a continuous source of on-demand power or storage, thus facilitating a balance between supply and demand for energy. For example, during low demand periods for electricity, excess electricity can be used with the one or more apparatuses disclosed herein to form dilute and concentrated solutions. Then, during periods of higher demand for electricity, power can be generated by circulating the dilute and concentrated solutions through the electrodialysis apparatus, thereby supplementing the supply of electricity to the grid.

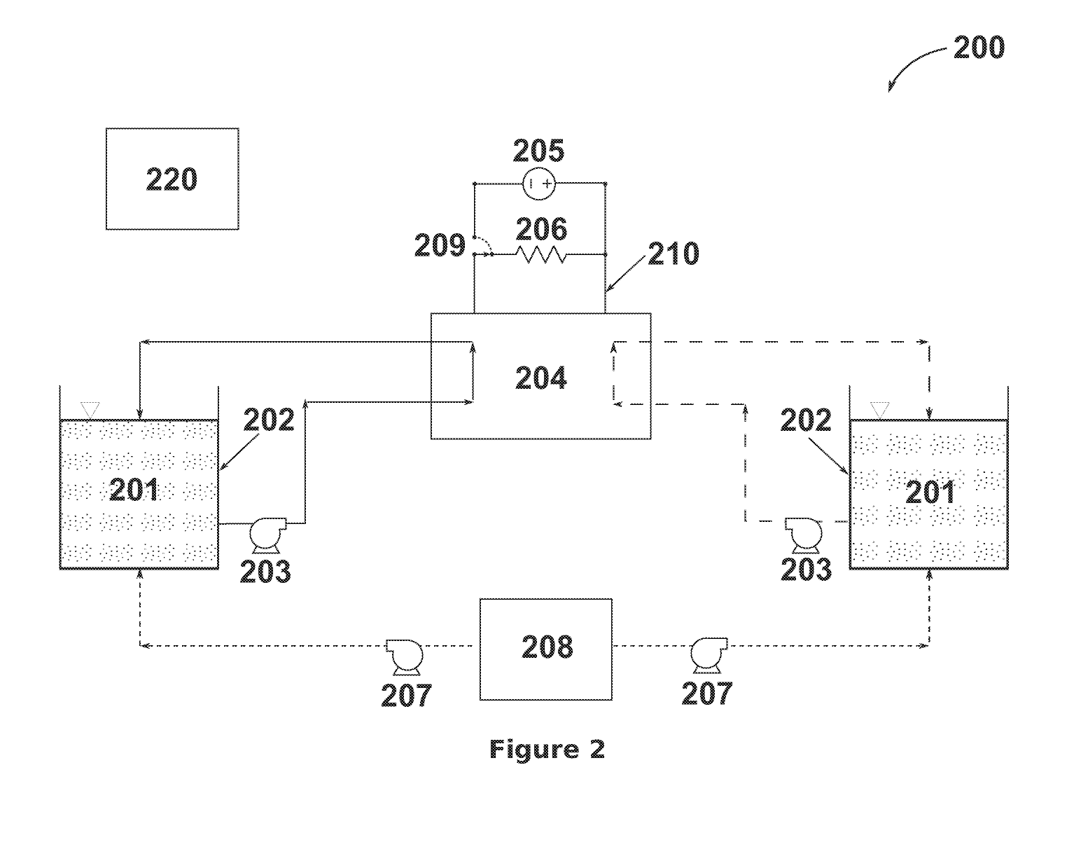

FIG. 2 provides an exemplary schematic view of a system (200) including one or more components of the one or more methods illustrated in FIG. 1. Electrolyte solutions (201) are stored in suitable storage tanks (202) of any appropriately configured size. A pump or other suitable device (203) may be used to circulate each solution through the reversible electrodialysis unit (204) and return it to the respective storage tank (202) in a substantially closed loop. The system (200) includes a source of electric power (205) connected by an electrical circuit (210) that may be activated when necessary to store energy. Similarly, the system (200) is connected to an external electric load (206) by an electrical circuit (210) to which it can deliver energy when needed. This may be directly connected to an electrical power grid (with appropriate converters), to a battery source, or to an industrial machine or other equipment. The system (200) may be alternately connected to the power source (205) or the electrical load (206) through an appropriately configured switch (209) in the electrical circuit (210). In this way, the system operates as a rechargeable battery. Chemical feed equipment (207) may be installed to deliver make-up water, additional solute, pH adjustment, or other chemicals (208) that may be required to condition the electrolyte solutions. The volume of said chemicals or makeup water shall be small relative to the volume of electrolyte solutions, such that the operation of the system remains substantially closed-loop.

In some embodiments, the system (200) may employ a digital or computerized control module (220) to regulate the flow of energy into or out of the reversible electrodialysis unit (204). This control module (220) may monitor the state of charge of the system by sensing the electrical potential between the electrodes, by counting the coulombs of charge that are delivered to or removed from the energy storage apparatus (e.g. by integrating electrical current through circuit 210 with respect to time), and/or by monitoring the concentration of ions in the respective solutions (201). The control module (220) may further monitor and regulate the fluid levels in the respective storage tanks (202), the conductivity, density, and temperature of the respective electrolyte solutions (201), the pumping rates of the respective solutions (201), and other parameters that may be helpful to the operation of the system (200).

The control module (220) may regulate operation of the apparatus (200) in response to a control signal, such as may be sent from a local control panel, a remote SCADA system, a mobile computing device such as a tablet or smartphone, or any other manner of control that is convenient for the parties responsible for operating the system. The system operators may manage the energy storage system in response to a control signal originating from a third party, such as the owner of the electrical grid to which the system is connected. The control module (220) may also have the ability to autonomously regulate operation of the apparatus (200) according to a schedule or some manner of sensing periods of low and high demand for electricity. For example, in one or more embodiments, the control module (220) may be configured to direct a first solution through the first solution inlet into the first flow channel and direct a second solution through the second solution inlet into the second flow channel, direct an electrical source to apply electrical potential to the apparatus to cause migration of ions from respective first and second solutions to form a dilute solution and a concentrated solution, and direct a pump to pump the dilute solution into a dilute solution storage tank and pump the concentrated solution into a concentrated solution storage tank. The control module 220 may then be further configured to determine a peak energy demand period for an electric grid, and, in response to determining a peak energy demand period, direct a pump to pump dilute solution into a dilute solution flow channel and pump concentrated solution into a concentrated solution flow channel in an electrodialysis apparatus to generate energy for delivery to an electrical load. Peak energy demand may be a period of hours and may be determined with further reference to electrical utility data provided by a utility provider, or may use historical data to predict future usage and demand.

The control module (220) would have the capability to start and stop the recirculation pumps (203), to adjust the pumping rate of the concentrated and dilute solution pumps (203) independently of one another, to open and close valves and switches (including but not limited to 209), to initiate or cease delivery of conditioning chemicals, and to connect or disconnect the apparatus from an external power source (205) or an electrical load (206). In this manner, the control module (220) may be used to automatically toggle the apparatus (200) between charging, storage, and discharging. The control module (220) may further regulate the state of multiple units connected in series or parallel, in some cases directing some units to charge while others are discharged. The control module (220) may further use monitoring data such as temperature, conductivity, density, or other parameters described above to optimize the operation of the system in real-time. For example, as the conductivities of the concentrated or dilute solutions change during a charging or discharging cycle, their respective pumping rates may be increased or decreased to minimize energy loss. In this manner, the control module (220) may be configured to determine one or more characteristics of the concentrated or dilute solutions during the charging or discharging cycles. Based upon determining a characteristic of the concentrated or dilute solutions, the control module (220) adjusts the pumping rate of the pumps in order to alter the flow rate of the dilute or concentrated solutions.

The sections that follow contain more detailed descriptions of each step in the one or more methods illustrated in FIG. 1.

### Reversible Electrodialysis Apparatus (FIG. 1, Item 101)

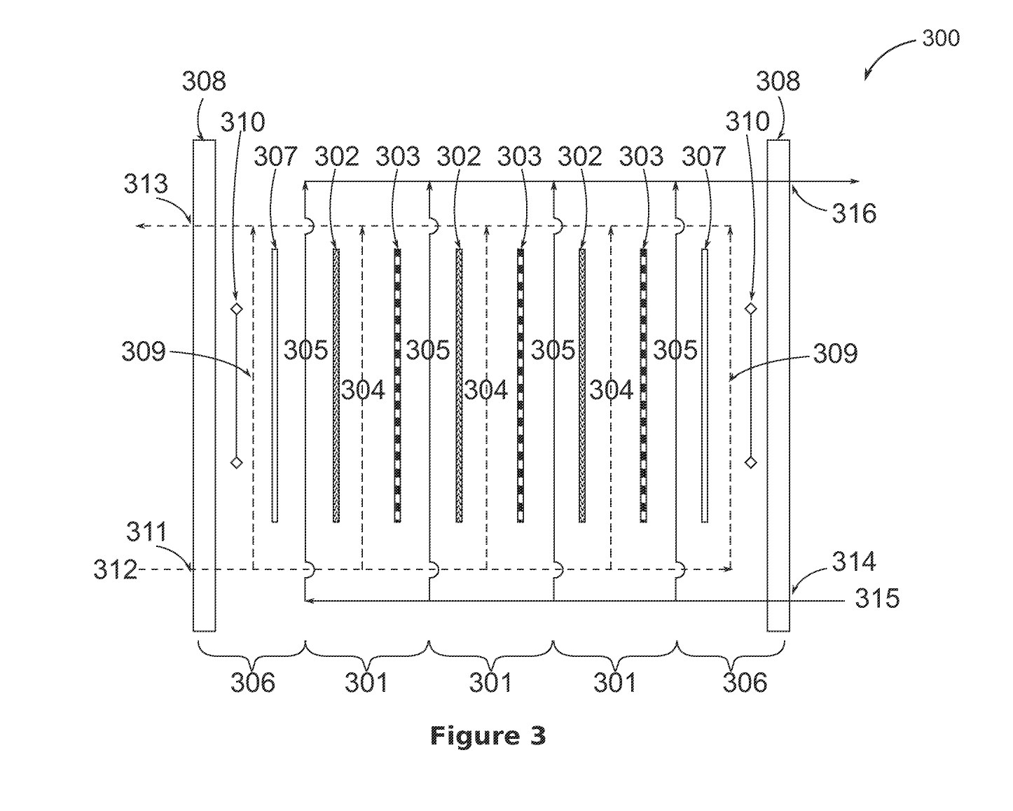

The reversible electrodialysis apparatus is similar in many respects to a conventional electrodialysis apparatus already described, except that each component has been optimized for reversible, closed-loop operation. An example of said apparatus is illustrated schematically in FIG. 3. The reversible electrodialysis apparatus (300) includes a stack of any appropriately configured number of flow cells (301), with flow cells (301) being identical in construction in one or more embodiments, each consisting of a cation exchange membrane (CEM, 302) and an anion exchange membrane (AEM, 303) that may be separated by a gasket and, optionally, a spacer (not shown). The gasket-spacer system may be provided to maintain a constant separation between opposing surfaces of the AEM and CEM, creating a first flow space (304). A second flow space (305) is created by the outer surface of the AEM (303) and the next flow cell in the membrane stack.

Compared to conventional or reverse electrodialysis systems known in the art, the spacing between membranes may be larger (as an example, 0.5 mm to 2.5 mm or more). The spacing between membranes may be larger because the electrolyte solutions (described below) are prepared in such a way that their electrical resistance is significantly lower than naturally-occurring fresh water. Since resistive energy losses are less significant with these solutions, a larger spacing may be advantageous if it reduces the hydraulic energy losses associated with pumping the solutions through the flow spaces increasing overall system efficiency.

Each end of the reversible electrodialysis unit may contain an electrode compartment (306). This compartment may be separated from the adjacent flow cell by an ion-permeable partition (307). In an exemplary embodiment, this partition may be the same type of AEM or CEM used in the membrane stack. The partition is separated from a battery end plate (308) by a gasket and, optionally, spacer (not shown) similar to those described for the membrane flow cells. The opposing faces of the battery end plate (308) and the partition (307) create an electrode flow space (309) through which electrode rinse solution is circulated. In an exemplary embodiment, this electrode rinse solution may be the same as one of the solutions (304 or 305) circulating through the membrane flow cells (301). The electrode flow space contains an electrode (310) and a manner of electrically connecting the electrode (310) to an external electrical circuit. Exemplary electrode materials may include stainless steel, carbon paper, carbon felt, or noble metal alloy electrodes. The electrodes may be porous, mesh, or solid. Many other suitable electrode materials are known in the art and are commercially available.

In an exemplary embodiment, the electrode (310) is inert, in that it does not contribute (e.g. via plating, deposition, or dissolution) to the electrochemical reactions giving rise to current flow. Exemplary inert electrode materials may include carbon, graphite, carbon felt, and noble metal alloy electrodes.

In an alternate embodiment, capacitative electrodes may be used. These electrodes accomplish electron transfer without any oxidation or reduction by either accumulating charge in an electrical double layer immediately adjacent to their surface, or by incorporating ions directly into their physical structure via intercalation. These electrodes are not suitable for continuous-flow processes such as conventional or reverse electrodialysis due to their finite charge storage capacity; however the closed-loop configuration of the one or more inventions disclosed herein enables their use as the flow process can be directed to cease by an operator or control module (220) when the capacitive system is nearing charge capacity. Exemplary capacitative electrode materials may include activated carbon, porous carbon, manganese oxide, and carbon aerogel. Other materials such as intercalation-type electrodes used in lithium ion battery systems may be suitable as well.

The battery end plate (308) may contain a first solution inlet port (311) through which a first electrolyte solution (312) can flow. The arrangement of the end plate (308), gaskets, and (optionally) spacers places the first solution (312) in fluid communication with the first flow spaces (304), while bypassing the second flow spaces (305). The first solution (312) flows through the membrane stack and exits the baseplate via a first solution outlet port (313). Similarly, a second solution inlet port (314) places a second electrolyte solution (315) in fluid communication with the second flow spaces (305), bypassing the first flow spaces (304). The second solution exits the apparatus through a second solution outlet port (316).

In some embodiments, the electrode compartments (306) may be isolated from the first and second solutions, and filled instead with a dedicated electrode rinse solution. A separate storage tank, feed pump, and inlet and outlet ports may be provided to recirculate this flow. Chemical feed equipment may be provided to deliver make-up water, additional solute, pH adjustment, or other chemicals that may be required to condition the electrode rinse solutions.

In some embodiments, one or both of the anion or cation exchange membranes may be selective to monovalent ions.

In some embodiments, one or both of the anion or cation exchange membranes may be selective to a specific ionic species, allowing the passage of a particular ion while denying passage to other ions of the same charge.

In some embodiments, a spacer may not be used between the membranes. Spacing between the membranes may be maintained by the gaskets and/or shaped protrusions integral to the membrane surface.

In some embodiments, a gasket may not be used between the membranes. Instead, a suitable type of sealant, caulk, or adhesive may be used to seal the membranes directly to the spacers.

In some embodiments, the reversible electrodialysis unit may define a spiral-wound configuration, comprising flat anion and cation exchange membranes and spacers rolled into a cylindrical vessel.

In some embodiments, the electrodialysis unit used for separating the first and second solutions may be different from the electrodialysis unit used for capturing the membrane potential generated by concentrated and dilute solutions.

In some embodiments, the electrodialysis unit used for separating the first and second solutions may be the same as the electrodialysis unit used for capturing the membrane potential generated by concentrated and dilute solutions.

Multiple reversible electrodialysis units connected to the same or different first and second solution storage tanks and/or the same electrical circuit may be arrayed in series or in parallel to provide different levels of current, voltage, or power output. The reversible electrodialysis unit may be designed with a modular enclosure to facilitate such arrangements.

### Electrolyte Solutions (FIG. 1, Item 102)

The first and second electrolyte solutions each may include one or more organic or inorganic ions dissolved in aqueous solution. A key advantage of the one or more systems disclosed herein over electrodialysis and reverse electrodialysis systems described in the art is that it is a closed-loop process. As a result, the composition of the first and second solutions may be engineered specifically for the purpose of storing energy. For reasons described below, it is advantageous to prepare a first and second electrolyte solution containing highly soluble ions which can be dissolved at high concentrations.

While the salt concentration in typical seawater is limited to approximately 0.5 mol/kg, a specially prepared brine may contain up to 6 mol/kg. The use of alternate salt compounds that are not commonly found in nature or industrial brines can enable ion concentrations of 10, 20, or even 40 mol/kg. These higher concentrations may increase the open circuit voltage of the system, allowing it to operate at a lower current and with fewer ohmic losses (for the same power output) than a system restricted to natural waters. Moreover, highly concentrated brines may offer lower electrical resistance than seawater, allowing the distance between membranes to be increased to between about 0.5 and about 2.5 mm or more in order to reduce pumping losses.

The electrical resistance of ion exchange membranes is known in the art as a key limiting factor in the development of reverse electrodialysis systems based on sea and river water. This resistance is partly a material property, but is also influenced significantly by the concentration of solutions surrounding the membrane. The resistance of commercially-available ion exchange membranes is commonly tested in a standard solution of 0.5M NaCl (roughly corresponding to seawater), and relatively little is known about how the resistance of said membranes changes when in contact with more concentrated solutions. One or more experiments disclosed herein have indicated that the resistance may decrease markedly for solutions containing 2 to 6 M sodium ions. Thus the use of more concentrated solutions enabled by a closed-loop process can reduce the internal energy losses that currently impede continuous-flow reverse electrodialysis.

In an exemplary embodiment, the first and second electrolyte solutions may contain at least one small, highly mobile cation (exemplary mobile cations include sodium, potassium, ammonium, lithium, and cesium), at least one small, highly mobile anion (exemplary mobile anions include chloride, bromide, iodide, formate, and acetate), and at least one larger, less-mobile “static” ion (exemplary static ions include calcium, magnesium, sulfate, and phosphate). When the battery is charged, the mobile cation and anion are exchanged across the respective membranes, moving into the concentrated solution. Due to its limited mobility, the “static” ion is partially retained in the dilute solution, maintaining a lower electrical resistance within the dilute solution flow spaces. In conventional or reverse electrodialysis, the addition of such an ion is both impossible (due to the natural source of the solutions) and, in the case of electrodialysis, violates the objective of the process, which is often treatment or purification of the dilute stream.

In an alternate embodiment, retention of the static ion may be improved by a reversible electrodialysis apparatus consisting only of monovalent-selective anion and/or cation exchange membranes, examples of which are commercially available. In an example, both the mobile cation and anion are monovalent ions (such as potassium and formate), while the static ion is a divalent ion such as sulfate. The static ion is retained in the dilute solution by the monovalent-selective membranes. Thus even after complete removal of monovalent ions, the presence of the static ion maintains a relatively low resistance in the dilute solution flow spaces, reducing energy loss through the system.

In some embodiments, the first and second solutions may comprise potable electrolytes, such that the solutions may be removed from the respective storage tanks and used to prepare a potable drink suitable for human consumption in an emergency.

In some embodiments, the first and second solutions may be provided to an end user in dry solid form to facilitate transport of the battery system by reducing the weight. Potable water may be added in the field to prepare the solutions for use.

In some embodiments, the first solution, second solution, or both may contain an organic solvent.

In some embodiments, the first and/or second electrolyte solutions may contain a soluble redox couple.

In some embodiments, the first and/or second electrolyte solutions may contain a complexing agent.

In some embodiments, the first and/or second electrolyte solutions may serve as the electrode rinse solution.

The first and second solutions are placed in fluid communication with alternating flow spaces within the reversible electrodialysis unit. In general, a peristaltic, diaphragm, centrifugal, or other suitable type of pump may be used to circulate each solution from its storage tank, through the reversible electrodialysis apparatus, and back, thus creating a closed recirculation loop for each solution. Previous applications of reverse electrodialysis in the art have been configured for continuous flow, one-way operation wherein a salinity gradient is used to generate electricity from naturally-occurring sources such as seawater and freshwater. In at least one embodiment of the present disclosure, no effluent stream is generated.

In some embodiments, solutions may be circulated by non-mechanical pumps such as those driven by electro-osmotic or magnetohydrodynamic principles.

In some embodiments, gravity, diffusion, or another passive manner may be used to provide contact between the solution and the flow spaces.

In some embodiments, the recirculation pumps for one or both solutions may be powered by electrical output from the reversible electrodialysis apparatus.

### Method for Charging the Battery (FIG. 1, Block 103)

Electric power is applied to the reversible electrodialysis apparatus through a source of electric power 205, causing current to flow between the electrodes. Whereas conventional electrolytic cells store all of their energy using oxidation and reduction reactions at the electrodes, in the one or more inventions disclosed herein oxidation/reduction reactions are used primarily to transfer charge from the electrolyte solutions into the electrical circuit, not to store energy.

A variety of well-known electrode systems may be used to accomplish this charge transfer. In one or more embodiments, the electrode system may include a soluble redox couple, having multiple chemical forms (characterized by different oxidation states) that can exist in dissolved aqueous solution (as an example iron, which may be dissolved in various forms of the +2 and the +3 oxidation state, including the Fe+2 and Fe+3 ions). This soluble redox couple may be a component of the first and second solutions, or it may reside in a separate electrode rinse solution that is isolated from the first and second solutions. The use of a soluble redox couple facilitates the use of reversible, inert electrodes and allows the power capacity of the system to be fully decoupled from the energy capacity. The behavior of the redox couple may be adjusted by adding a complexing agent, such as citrate, ethylenediaminetetraacetic acid (EDTA), Ethylenediamine-N,N′-disuccinic acid (EDDS), Iminodisuccinic acid (IDS), or a variety of other well-known substances.

Irrespective of the type of reaction taking place at the electrodes, the arrangement of ion exchange membranes in the reversible electrodialysis apparatus forces anions to move in a first direction and cations to move in a second direction opposite the first, such that both cations and anions migrate out of the first solution and into the second solution. Thus, the first and second solutions become dilute and concentrated, respectively. Chemical energy is stored in this concentration gradient. The energy stored can be calculated according to the difference in Gibbs Free energy between the starting and ending states of the respective solutions:

E_separation=G concentrate+G_dilute−G_blend (1)

G=−RT sum n_ln {a_} (2)

In which E_separation represents the energy required to separate an initial blended solution into a concentrated and dilute solution, G_blend, G_concentrate, and G_dilute represent the Gibbs free energy of the (initial) blended solution and the (final) concentrated and dilute solutions, respectively, R is the universal gas constant, T is the absolute temperature, and n_i and a_i represents the number of moles and activity of the ith component in the solution, respectively, and the summation is carried out over all components in the solution. The activity of an ion corresponds generally to its concentration (or moles per volume). Thus more energy may be stored in solutions containing high concentrations of ions.

In this way, separating the electrolyte solutions into a concentrated and a dilute part may convert electrical energy into chemical potential energy in the form of the concentration gradient between the first and second solutions.

In one illustrative embodiment, the chemical reaction taking place at the cathode may be reversed at the anode, such that there is no net oxidation or reduction reaction taking place in the apparatus. As an example, when the redox couple is iron:

At the anode: Fe+2=>Fe+3+e− (3)

At the cathode: Fe+3+e−=>Fe+2 (4)

In this illustrative embodiment, no energy can be stored via oxidation or reduction because there is no net reaction. All energy is stored in the concentration gradient between the electrolyte solutions, as explained above. This property of the one or more inventions disclosed herein is further illustrated by the fact that capacitative electrodes, which do not involve oxidation or reduction, may be used.

### Storage of Electrolyte Solutions (FIG. 1, Item 104)

Once a concentration gradient between the first and second solutions is established, the respective first solution and second solution may be stored in isolation from one another in any appropriately sized containers. In general, the storage containers may be approximately equal in size. Mechanical or hydraulic mixers or other suitable manners of maintaining a uniformly-mixed condition within each container may be provided.

If the volume of the containers is large relative to the volume inside the reversible electrodialysis unit, storage may be accomplished by ceasing circulation so that the bulk of the solution remains outside the reversible electrodialysis apparatus. If the volume of the containers is similar to or smaller than the volume inside the reversible electrodialysis apparatus, isolation valves may be employed to prevent ions inside the storage containers from migrating into the apparatus by diffusion.

In some embodiments, the volume of the concentrated and dilute solution storage containers (and the solutions therein) may be different. In one example, the volume of the dilute solution may be 1.5 to 2.5 times greater than the concentrated solution volume.

In some embodiments, the volume of the concentrated solution storage container may be substantially reduced relative to the volume of the dilute solution storage container by the use of controlled precipitation. For example, recirculating concentrated solution can be brought into contact with a granular solid form of the predominant dissolved ion(s), either by maintaining a bed of solid electrolyte in the bottom of the concentrated solution storage tank or by passing the solution through a cartridge or packed bed of said material. As the solution becomes more concentrated during a charging cycle, excess electrolyte will precipitate as a solid into the storage tank, packed bed, or cartridge.

A notable feature of the battery system is that increasing the energy storage capacity (kWh) requires only adding storage tank capacity or increasing the concentration gradient between the solutions. An increase in the size of electrodes, membranes, or other elements of the reversible electrodialysis apparatus is not required.

During storage, chemical feed equipment may be employed to deliver make-up water, additional solute, conditioning chemicals, or pH adjustment to the electrolyte solutions. The volume of these added chemicals is small relative to the total solution volume, such that the process remains substantially closed-loop.

### Method for Discharging the Battery (FIG. 1, Block 105)

To generate electricity, the first and second electrolyte solutions (now having different concentrations of ions) may be circulated through the reversible electrodialysis unit, and electricity may be generated through reverse electrodialysis. The passage of ions across the respective ion exchange membranes generates an electrical current, and a corresponding potential (voltage) may be generated across each membrane according to the Nernst Equation:

V=RT/zF ln ({C}/{D}) (5)

where R is the universal gas constant, T is the absolute temperature, and F is the Faraday constant, z is the charge on the ion being transported, and {C} and {D} are the activities of the ion in the concentrated and dilute solutions, respectively. The activity of an ion corresponds generally to its concentration; therefore, the greater the concentration difference between solutions, the greater the voltage.

When the concentrated and dilute solutions are introduced into alternating compartments of the reversible electrodialysis apparatus, the propensity of ions in the concentrated solution to diffuse into the dilute solution causes ionic current to flow. The arrangement of ion exchange membranes forces anions to move in a first direction and cations to move in a second direction opposite the first. At each electrode, the accumulation of cations or anions causes charge to be transferred through the electrode into the external electrical circuit.

The one or more inventions disclosed herein thus provides a manner of converting the energy of mixing of the first and second solutions directly into electricity. Other rechargeable electrochemical systems taught by the art require a net oxidation or reduction to produce energy, restricting the types of suitable electrolytes, and often requiring the use of rare, hazardous, or expensive materials such as lithium (mobile device batteries), sulfuric acid (car batteries), or vanadium (flow batteries).

This direct harnessing of mixing energy allows the one or more inventions disclosed herein to employ a variety of common salt solutions with a near-neutral pH and low toxicity as the energy storage mechanism. In an exemplary embodiment, the predominant salt in the solution is potassium formate. Other exemplary materials may include magnesium chloride, sodium formate, cesium formate, sodium, potassium, or cesium acetate, and zinc chloride.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

### Experiment 1

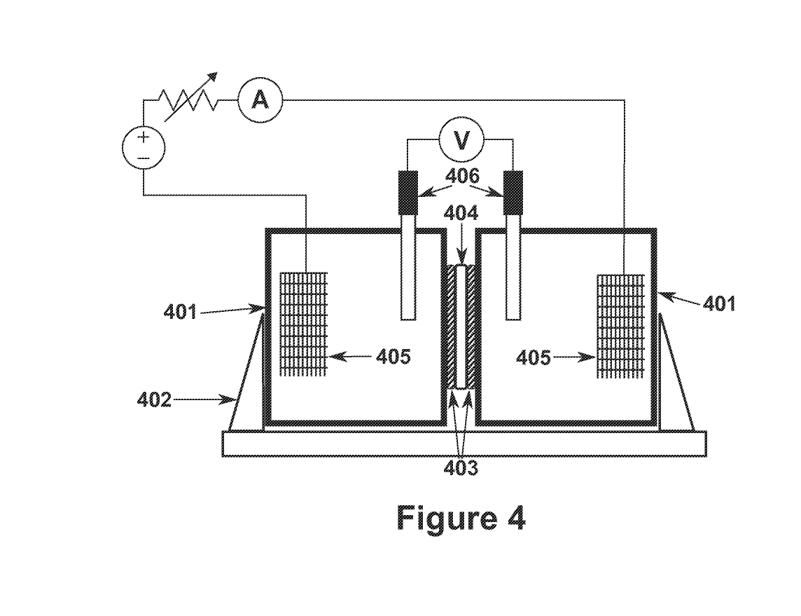

In a first experiment, the resistance of ion exchange membranes in 0.5 m, 2 m, 4 m, and 6 m NaCl solutions was measured using a testing apparatus illustrated in FIG. 4. Numbers in this paragraph refer to elements of this figure. The testing apparatus includes two 3-L square acrylic jars (401) held together by a clamp (402). A pattern of holes drilled into one face of each jar allowed fluid communication between the two jars. EPDM gaskets (403) were used to seal the open face to an ion exchange membrane (404) that divided the chambers. Stainless steel mesh electrodes (working electrodes, 405) were placed in opposing ends of the testing apparatus and were connected to a 5V DC power supply in series with a variable resistance and a multimeter measuring current (Radio Shack 22-182). Ag/AgCl reference electrodes (Cole Parmer Company, 406) were installed in each chamber adjacent to the open face and were connected to a multimeter measuring voltage (Fluke 87). Initially the two jars were sealed together with no membrane in between. A 0.5 mol/kg solution of food-grade sodium chloride (CAS #7647-14-15) in distilled water was used to fill both chambers of the testing apparatus. This concentration roughly corresponds to the salinity of seawater, and is commonly used by commercial membrane manufacturers as the basis for published performance data. The power supply was activated, causing electrical current to move through the stainless steel electrodes and into the solution via electrolysis of water. The amount of electrical current passing through the test chamber was modulated by varying the resistance. Voltage and current measurements were recorded after each adjustment. After completing a sweep of at least four current values, the resistance of the solution was calculated by fitting a line through the plot of current-voltage measurements. The process was repeated with an anion exchange membrane (Neosepta ACS) and a cation exchange membrane (Neosepta CMS) installed in between the chambers. Comparing the calculated resistance of the solution alone with the resistance of the solution and membrane provided an estimate of the electrical resistance of the membrane itself This process was repeated with 2 m, 4 m, and 6 m solutions of NaCl. Several days later, fresh solutions were prepared and all measurements were repeated. During the second experiment, membranes were allowed to equilibrate in the test solutions for 24 hours prior to measurement. Data are shown in Table I that follows.

TABLE I
Resistance of ion exchange membranes in NaCl solution.
Values shown are the average of duplicate experiments.

| NaCl | | | | | |
|---|---|---|---|---|---|
| Concen- | Measured Resistance, ohms | | | Membrane | |
| tration | | Solution + | Solution + | Resistivity, ohm-m2 | |
| mol/kg | Solution | AEM | CEM | AEM | CEM |
| 0.5 | 3.0393 | 3.4661 | 3.1967 | 8.97e−4 | 3.31e−4 |
| 2.0 | 0.9207 | 1.1802 | 1.0510 | 5.45e−4 | 2.74e−4 |
| 4.0 | 0.5882 | 0.8446 | 0.6946 | 5.39e−4 | 2.24e−4 |
| 6.0 | 0.5264 | 0.8568 | 0.6183 | 6.95e−4 | 1.93e−4 |

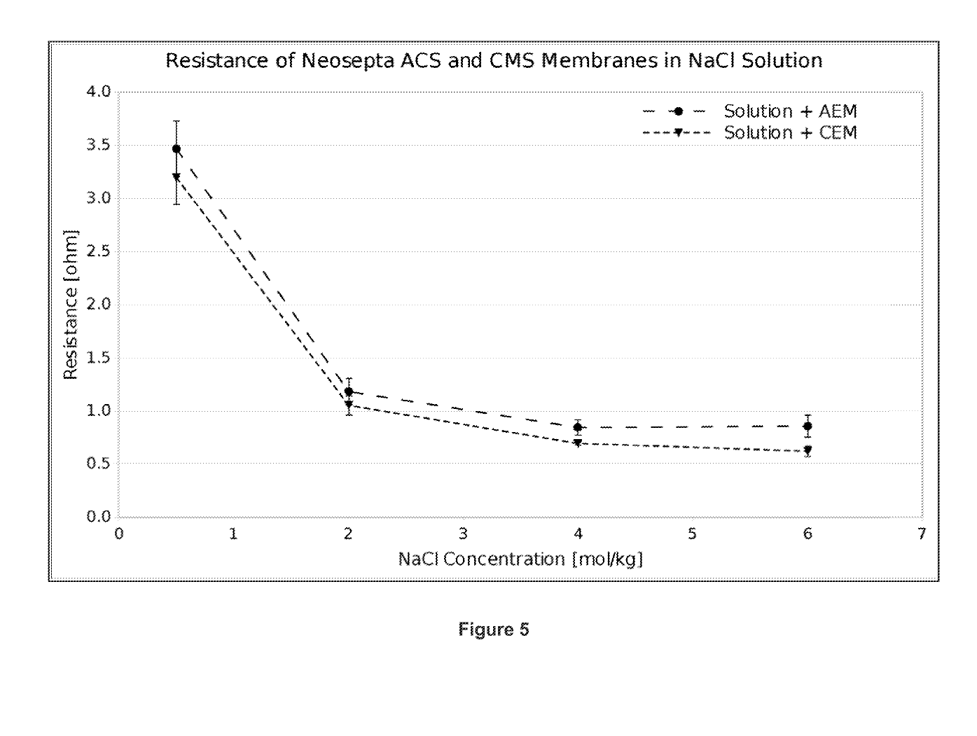

Analysis of the data shows that the total resistance of the solution and ion exchange membrane was reduced by approximately 75% in 6 m NaCl compared to 0.5 m NaCl. These results are shown in FIG. 5.

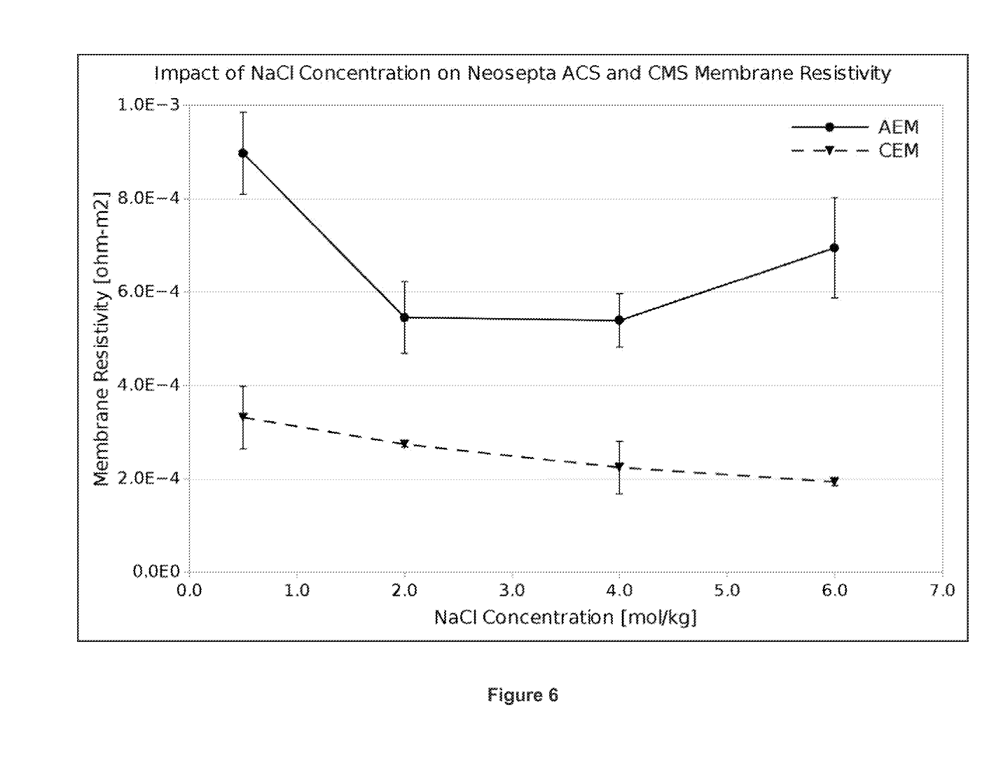

The resistances attributable to the AEM and CEM were reduced by 20% and 50%, respectively. While the CEM resistance appeared to continue a decreasing trend with concentration, the AEM resistance showed a minimum at 4 m NaCl and increased again in the more concentrated 6 m solution. These trends are illustrated in FIG. 6.

### Experiment 2

In a second experiment, the above procedure was repeated using 0.5 m, 4.4 m, and 9.3 m solutions of sodium formate (CAS #141-53-7) in distilled water. Membranes were allowed to equilibrate for 18 hours prior to measurement. Data are given in Table II that follows.

TABLE II
Resistance of ion exchange membranes in sodium formate solution.

| | | | | Membrane | |
|---|---|---|---|---|---|
| Concen- | Measured Resistance, ohms | | | Resistivity, | |
| tration | | Solution + | Solution + | ohm-m2 | |
| mol/kg | Solution | AEM | CEM | AEM | CEM |
| 0.5 | 3.1724 | 3.5315 | 3.4579 | 7.6e−4 | 6.0e−4 |
| 4.4 | 0.8552 | 1.1516 | 1.0024 | 6.2e−4 | 3.1e−4 |
| 9.3 | 1.0785 | 1.5249 | 1.2499 | 9.4e−4 | 3.6e−4 |

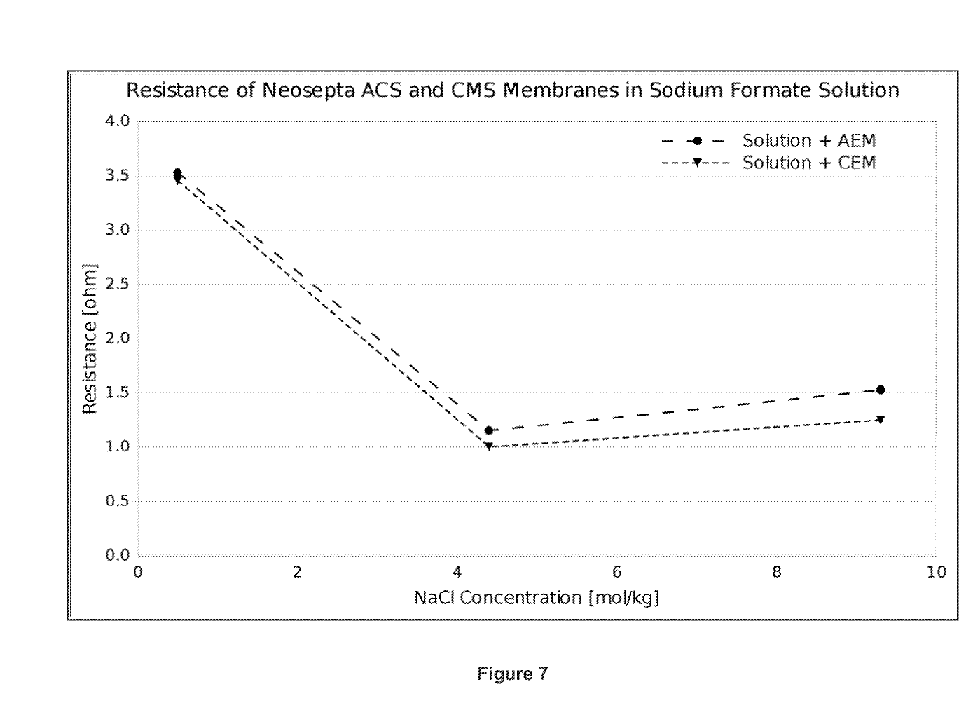

The total resistance of the solution and ion exchange membrane was reduced by approximately 60% in the 9.3 m solution compared to the 0.5 m solution, as shown in FIG. 7

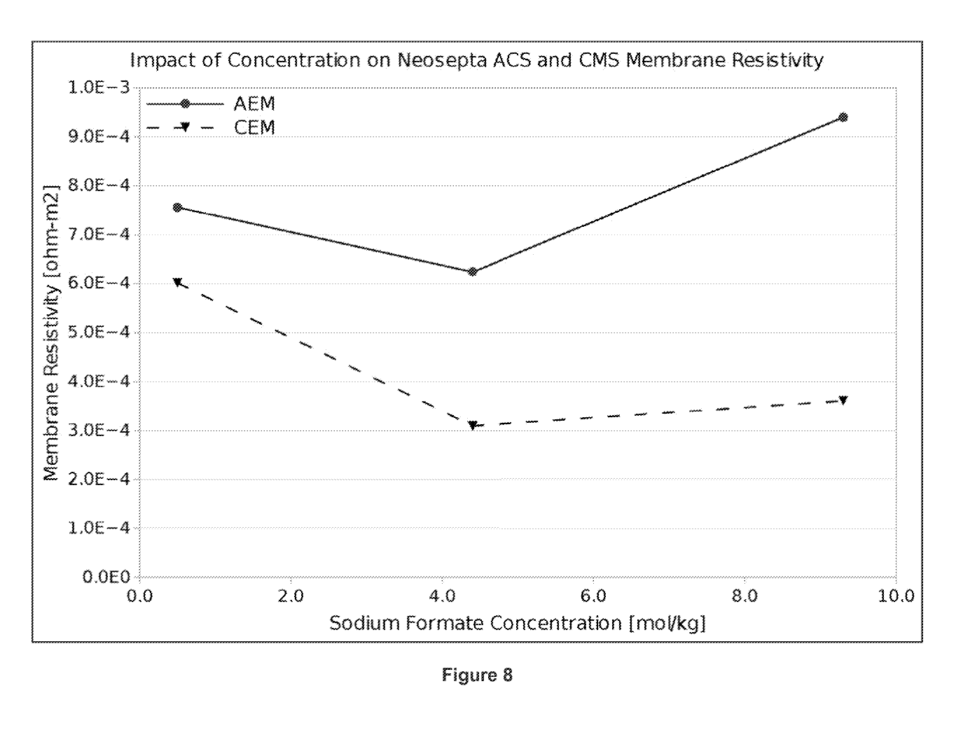

The resistance attributed to the CEM was reduced by approximately 35% in 9.3 m solution compared to 0.5 m solution, while the resistance of the AEM increased by approximately 25%. As before, the AEM resistance exhibited a minimum near 4 m, while the CEM seemed to plateau above 4 m. These trends are shown in FIG. 8.

### Experiment 3

In a third experiment, a Neosepta ACS AEM was installed in the test apparatus described in FIG. 4, however the working electrodes (5) were omitted. One side of the cell was filled with an approximately 6 m solution of sodium formate, while the other side was filled with distilled water. The reference electrodes (6) were used to measured the membrane potential generated across the membrane. The apparatus was allowed to sit for four weeks while periodic voltage measurements were taken. In this way, the “self-discharge” of the apparatus via diffusion of ions through the ion exchange membrane could be assessed.

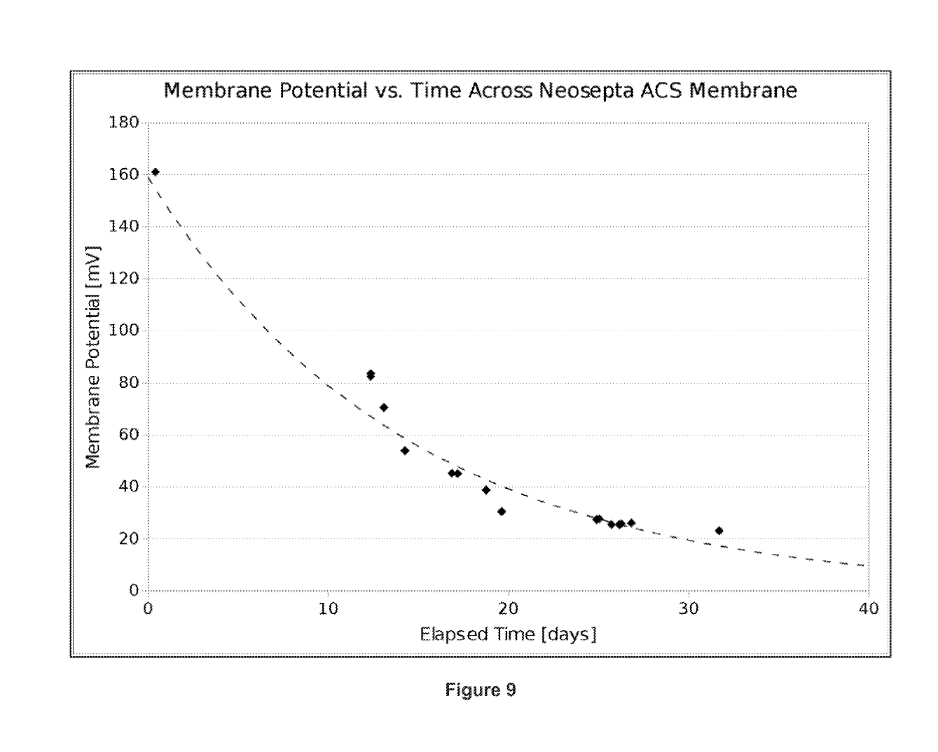

Over the course of four weeks, the measured membrane potential declined from 161 mV to 26.1 mV, corresponding to a self-discharge rate of less than 3% per day. A graph of the measured membrane potential (cell voltage) over time is shown in FIG. 9. The system described in this application is envisioned for the storage of energy for hours to a few days, so these results indicate that a concentration gradient is a suitable manner for storing energy. In an actual system, the fraction of the total solution volume remaining in contact with the ion exchange membranes would be smaller, reducing the rate of diffusion and resulting in even slower rates of self-discharge.

### Experiment 4

In a fourth experiment, an electrodialysis apparatus was constructed using three Neosepta ACS anion exchange membranes and two Neosepta CMS ion exchange membranes arranged in an alternating stack. Each membrane was sealed between styrene spacers so as to create alternating flow spaces as described above. (An odd number of membranes was used so that one electrode would communicate with each set of flow spaces). Ag/AgCl reference electrodes (Cole Parmer Company) were installed at either end of the membrane stack to measure the voltage difference across the stack. Carbon rods connected to copper wire were placed on the outermost ends of the stack to function as working electrodes.

First, solutions of 0.5M and 0.005M sodium chloride (CAS #7647-14-15) in distilled water, representing typical sea and river water, were circulated through the concentrated and dilute solution flow spaces, respectively. A DC power supply and a variable resistance were used to drive varying levels of electric current across the membrane stack. Current and voltage were recorded using multimeters. The resistance of the stack was determined by the slope of the current-voltage line, while the intercept of the line represents the open circuit voltage arising from membrane potential.

Next, the test was repeated using more concentrated solutions. 8.2M sodium formate and 0.1M sodium formate (CAS #141-53-7) solutions (prepared in distilled water) were circulated through the concentrated and dilute solution flow spaces, respectively.

Current-Voltage data for both experiments are given in Table III. The resistance of the apparatus when using simulated sea and river water was 52.9 ohms, while the resistance of the apparatus using more concentrated solutions was only 3.7 ohms. This 14-fold reduction in resistance highlights one of the advantages of a closed-loop approach to (reverse) electrodialysis.

TABLE III
Current-Voltage Data through Reversible Electrodialysis Apparatus

| 0.5 M/0.005 M Sodium Chloride | | 8.2 M/0.1 M Sodium Formate | |
|---|---|---|---|
| Current, mA | Voltage, mV | Current, mA | Voltage, mV |
| 0 | 489 | 0 | 417 |
| 7.2 | 860 | 5 | 441 |
| 6.6 | 832 | 8 | 452 |
| 4.6 | 729 | 18.4 | 488 |
| 3.4 | 666 | 29 | 528 |
| 11.7 | 1110 | — | — |
| Slope (Resistance, ohm) | 52.9 | Slope (Resistance, ohm) | 3.7 |
| Intercept (OCV, mV) | 485.6 | Intercept (OCV, mV) | 420.1 |
| R-Squared | 1.000 | R-Squared | 0.997 |

The open circuit voltage generated by the sodium chloride and sodium formate was 0.485V and 0.420V, respectively. Since both pairs of solutions had a similar ratio of concentrations (100:1 for sodium chloride and 82:1 for sodium formate), the similarity between the open circuit voltages is consistent with expectations.

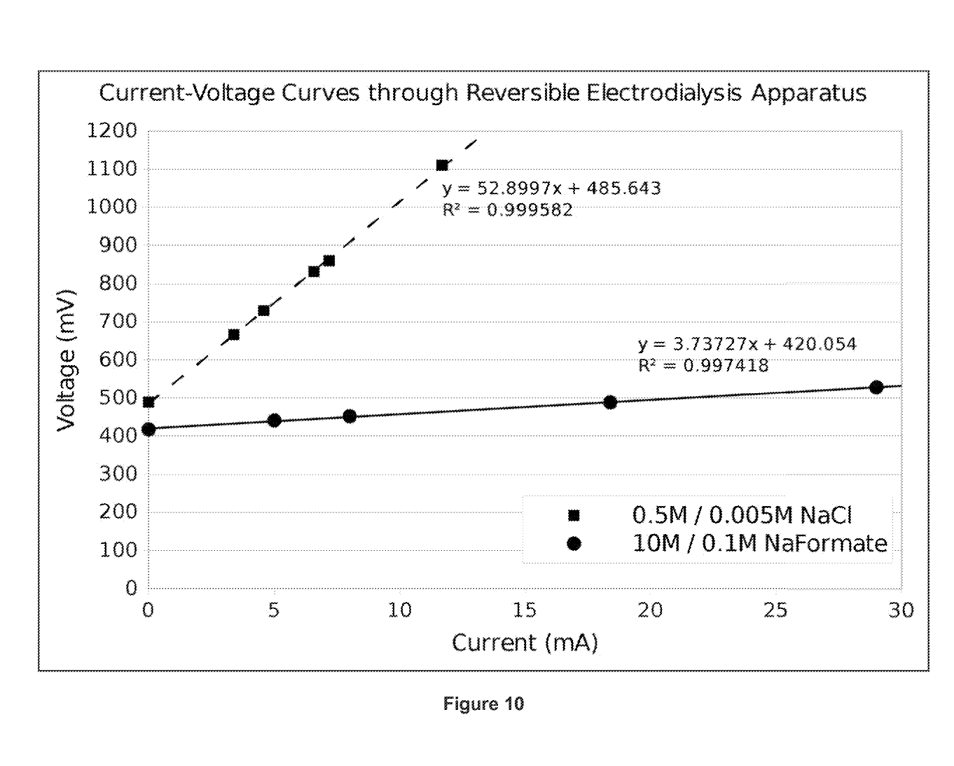

Current-voltage curves illustrating the open-circuit voltage (intercept) and overall resistance (slope) created by both solution pairs are shown in FIG. 10.

What is claimed is:

1. A method for storing and releasing electrical energy, comprising:
placing a first electrolyte solution in a first flow channel defined between an anion exchange membrane (AEM) and a cation exchange membrane (CEM) and a second electrolyte solution in a second flow channel defined between an AEM and a CEM;
passing electrical current through the flow channels to cause the first solution to become more dilute and the second solution to become more concentrated;
circulating the dilute solution into a dilute solution flow channel defined between an AEM and a CEM and the concentrated solution into a concentrated solution flow channel defined between an AEM and a CEM; and
converting a membrane potential defined by the concentration difference between the solutions separated by a membrane into an electrical current.

2. The method of claim 1, further including adding chemical salts to a water solution to form the first electrolyte solution and the second electrolyte solution.

3. The method of claim 2, in which the ions that are added to each of the first and second electrolyte solutions comprise at least one monovalent cation, at least one monovalent anion, and at least one multivalent cation or anion.

4. The method of claim 2, wherein the salt concentration in each of the first electrolyte solution and the second electrolyte solution are about the same.

5. The method of claim 2, wherein the salt concentration in each of the first electrolyte solution and the second electrolyte solution are equal.

6. The method of claim 2, wherein the first electrolyte solution and/or the second electrolyte solution contain one or more unique chemical components (ionic species) that are not present in the other solution.

7. The method of claim 2, wherein adding chemical salts to a water solution comprises adding a salt at greater than 0.5 molar concentration.

8. The method of claim 2, in which one or more of the AEMs or CEMs are selective toward monovalent ions.

9. The method of claim 8, in which the ions that are added to each of the first and second electrolyte solutions comprise at least one monovalent cation, at least one monovalent anion, and at least one multivalent cation or anion.

10. The method of claim 1, wherein the predominant anion (by concentration) in the first or second electrolyte solution is from one of formate, acetate, chloride, bromide, and iodide.

11. The method of claim 1, wherein the predominant cation (by concentration) in the first or second electrolyte solution is from one of sodium, potassium, cesium, and ammonium.

12. The method of claim 1, further including converting the electrical current for connection to an electrical load.

13. The method of claim 1, wherein the first flow channel is the dilute solution flow channel, and the second flow channel is the concentrated solution flow channel.

14. A reversible electrodialysis system, comprising:
an electrodialysis apparatus that includes:
a stack of one or more membrane flow cells, each cell comprising an anion exchange membrane (AEM) and a cation exchange membrane (CEM);
a first solution inlet through which a first electrolyte solution is introduced to a first flow channel defined by a first surface of an AEM and first surface of an adjacent CEM;
a second solution inlet through which a second electrolyte solution is introduced to a second flow channel defined by the opposite surface of an AEM or CEM and a first surface of an adjacent AEM or CEM;
a cathode compartment and an anode compartment; and
a control module configured to:
direct a first solution through the first solution inlet into the first flow channel and direct a second solution through the second solution inlet into the second flow channel,
direct an electrical source to apply electrical potential to the apparatus to cause migration of ions from respective first and second solutions to form a dilute solution and a concentrated solution,
direct a pump to pump the dilute solution into a dilute solution storage tank and pump the concentrated solution into a concentrated solution storage tank,
determine a peak energy demand period for an electric grid, and
in response to determining a peak energy demand period, direct a pump to pump dilute solution into a dilute solution flow channel and pump concentrated solution into a concentrated solution flow channel in an electrodialysis apparatus to generate energy for delivery to an electrical load.

15. The device of claim 14, in which the cathode and anode compartment contain capacitative electrodes.

16. The device of claim 14, wherein the spacing between an adjacent AEM and CEM is between about 0.5 mm and about 2.5 mm.

17. The device of claim 14, wherein either the first or the second solution is configured to flow through both the anode and cathode flow spaces.

18. The device of claim 14, wherein the first solution flows through the anode flow space and the second solution flows through the cathode flow space.

19. The device of claim 14, in which any solution configured to flow through the anode or cathode flow spaces contains a soluble redox couple.

20. The device of claim 19, wherein the soluble redox couple is Iron(II)/Iron(III).

21. The device of claim 14, wherein the first flow channel is the dilute solution flow channel, and wherein the second flow channel is the concentrated solution channel.

22. A method for storing and releasing electrical energy, comprising:
placing a first electrolyte solution in a first flow channel defined between an anion exchange membrane (AEM) and a cation exchange membrane (CEM) and a second electrolyte solution in a second flow channel defined between an AEM and a CEM;
during a period of low energy demand, applying electrical current through the flow channels to cause the first solution to become more dilute and the second solution to become more concentrated;
during a period of high energy demand, circulating the dilute solution into a dilute solution flow channel defined between an AEM and a CEM and the concentrated solution into a concentrated solution flow channel defined between an AEM and a CEM; and
converting a membrane potential defined by the concentration difference between the solutions separated by a membrane into an electrical current.
